(19) United States
(12) Patent Application Publication
(10) Pub. No.: US 2015/0276382 A1
(43) Pub. Date: Oct. 1, 2015

(54) MEASUREMENT MARK STRUCTURE

(71) Applicant: UNITED MICROELECTRONICS CORP., Hsin-Chu City (TW)

(72) Inventors: En-Chiuan Liou, Tainan City (TW); Kuei-Chun Hung, Hsin-Chu City (TW); Chun-Chi Yu, Taipei City (TW)

(73) Assignee: UNITED MICROELECTRONICS CORP., Hsin-Chu City (TW)

(21) Appl. No.: 14/226,834

(22) Filed: Mar. 27, 2014

(51) Int. Cl. G01B 11/14; G01B 11/28

(52) U.S. Cl. CPC G01B 11/14; G01B 11/28

(57) ABSTRACT

A measurement mark structure includes a mark pattern and a pair of assistant bars positioned at two opposite sides of the mark pattern. The mark pattern includes a plurality of segments. The segments of the mark pattern are arranged along a first direction and the pair of the assistant bars are expend along the first direction.

### BACKGROUND OF THE INVENTION

1. Field of the Invention

The invention relates to a measurement mark structure, and more particularly, to a measurement mark structure integrated in segment-cutting process.

2. Description of the Prior Art

Photolithography is one of the most critical steps in semiconductor manufacturing processes. Due to the trend toward shrinking the dimensions of the semiconductor devices for improving performance and reduce cost, the key consideration of the photolithography process is not only the critical dimension, but also the alignment accuracy. In the case that the alignment accuracy is imprecise, the circuit patterns may not be connected to the circuit patterns in pre- or successive layers and resulted in failure of the device or the whole integrated circuit (IC). The alignment accuracy measurement is therefore taken as one of the most important measurements in the semiconductor manufacturing processes. And thus alignment measurement marks and/or overlay measurement marks are always formed on the wafers and the various material layers in order to improve the alignment accuracy.

However, it is observed that patterns or structures of the measurement marks itself also affect the result of alignment accuracy measurement. For example, in the fin field effect transistor (hereinafter abbreviated as FinFET) process, edge roughness often occurs at the overlay measurement marks, which are formed simultaneously with forming the fin layers for accommodating the sources/drains. The edge roughness issue causes severe measurement deviation when the overlay measurement marks are scanned, and thus the result of alignment accuracy measurement is adversely impacted.

### SUMMARY OF THE INVENTION

According to an aspect of the present invention, a measurement mark structure is provided. The measurement mark structure includes a mark pattern and a pair of assistant bars positioned at two opposite sides of the mark pattern. The mark pattern includes a plurality of segments. The segments are arranged along a first direction and the pair of assistant bars are extended along the first direction.

According to another aspect of the present invention, a measurement mark structure is provided. The measurement mark structure includes a substrate, a plurality of first mark patterns positioned on the substrate, and a plurality of pairs of first assistant bars positioned on the substrate. The first mark patterns are respectively sandwiched between one pair of first assistant bars. The first mark patterns respectively include a plurality of first segments, and the first segments are arranged along a first direction. The pairs of first assistant bars are extended along the first direction.

According to the measurement mark structure provided by the present invention, a pair of assistant bars is positioned at two opposite sides of any given mark pattern. And an extending direction of the assistant bars is the same with an arrangement direction of mark pattern. The assistant bars efficaciously remedy the edge rough problem, and thus alignment accuracy measurement is improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-4 are schematic drawings illustrating a measurement mark structure provided by a first preferred embodiment of the present invention, wherein

FIG. 2 is a schematic drawing in a step subsequent to FIG. 1,

FIG. 3 is a schematic drawing in a step subsequent to FIG. 2, and

FIG. 4 is a schematic drawing in a step subsequent to FIG. 3.

FIG. 5 is a schematic drawing illustrating a measurement mark structure provided by a second preferred embodiment of the present invention.

FIG. 6 is a schematic drawing illustrating a modification to the second preferred embodiment.

FIG. 7 is a schematic drawing illustrating another modification to the second preferred embodiment.

### DETAILED DESCRIPTION

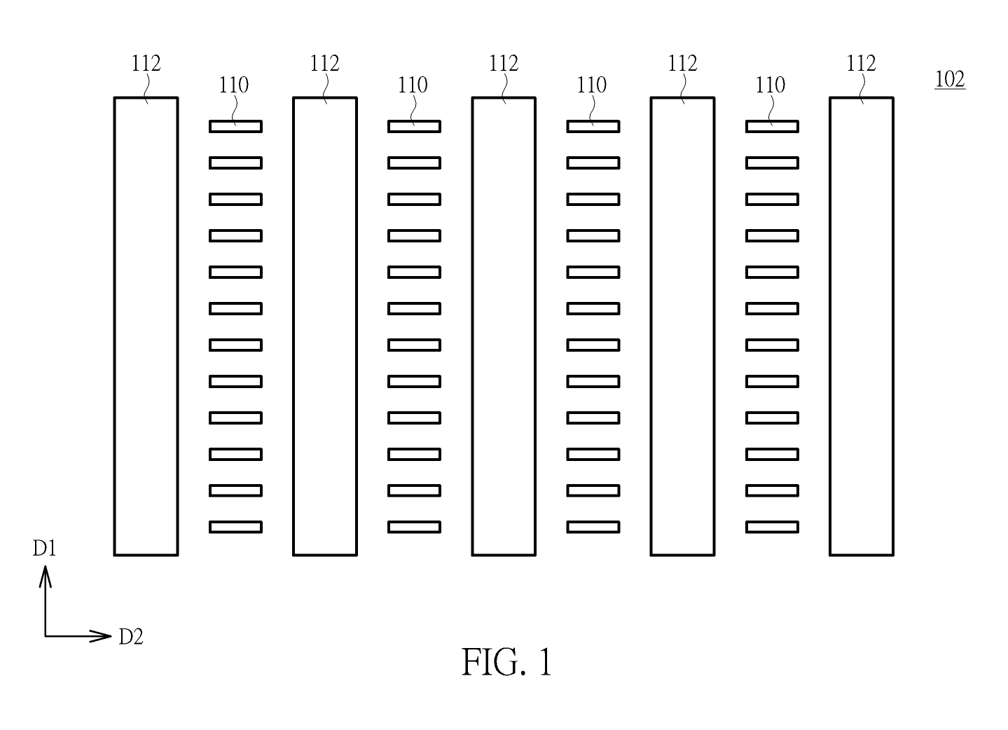

Please refer to FIGS. 1-4, which are schematic drawings illustrating a measurement mark structure provided by a first preferred embodiment of the present invention. As shown in FIG. 1, a measurement mark structure 100 provided by the preferred embodiment is formed by following steps. A substrate 102 is provided. Next, a plurality of first mandrel patterns 110 and a plurality of second mandrel patterns 112 are formed on the substrate 102. It is well-known to those skilled in the art that the measurement mark structure is formed concurrently with forming a specific material layer/pattern or a specific device. Therefore alignment accuracy between the specific material layer/pattern and a pre-layer or a successive layer can be measured. In accordance with the preferred embodiment, the measurement mark structure 100 is formed along with fin layers of FinFET. Therefore, those skilled in the art would easily realize that a plurality of mandrel patterns (not shown) are formed in active regions in the substrate 102 simultaneously with forming the first mandrel patterns 110 and the second mandrel patterns 112. Accordingly, the first mandrel patterns 110 and the second mandrel patterns 112 include polysilicon in the preferred embodiment, but not limited to this.

Please still refer to FIG. 1. The first mandrel patterns 110 and the second mandrel patterns 112 both include strap shapes. And the first mandrel patterns 110 and the second mandrel patterns 112 are alternately arranged. More important, the second mandrel patterns 112 are respectively positioned at two opposite sides of any given first mandrel pattern 110. It is also noteworthy that a size of the second mandrel patterns 112 is much larger than a size of the first mandrel patterns 110. The first mandrel patterns 110 are arranged along a first direction D1 and the strap-shaped first mandrel patterns 110 are extended along a second direction D2 while the strap-shaped second mandrel patterns 112 are extended along the first direction D1. As shown in FIG. 1, the first direction D1 and the second direction D2 are perpendicular to each other.

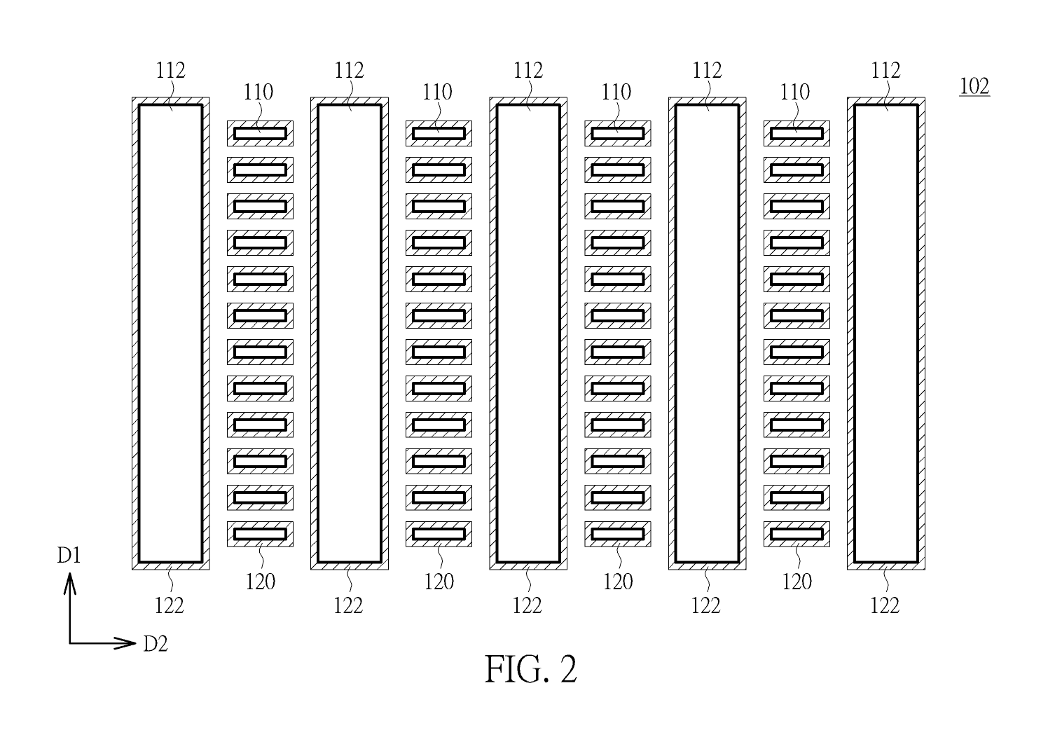

Please refer to FIG. 2. Next, a spacer layer (not shown) is formed on the substrate 102. The spacer layer can include silicon oxide, silicon nitride, silicon oxynitride and/or any suitable materials of which an etching rate is different from the mandrel patterns 110/112. Subsequently, an etching back process is performed to the spacer layer, and thus a first spacer 120 is formed on sidewall of each first mandrel pattern 110 and a second spacer 122 is formed on sidewall of each second mandrel pattern 112. As mentioned above, since the measurement mark structure 100 is integrated in the FinFET process, and is used to measure the alignment accuracy between the fin layer and pre-/successive layers, a spacer is formed on sidewall of each mandrel pattern in the active regions of the substrate 102 simultaneously with forming the first spacers 120 and the second spacers 122.

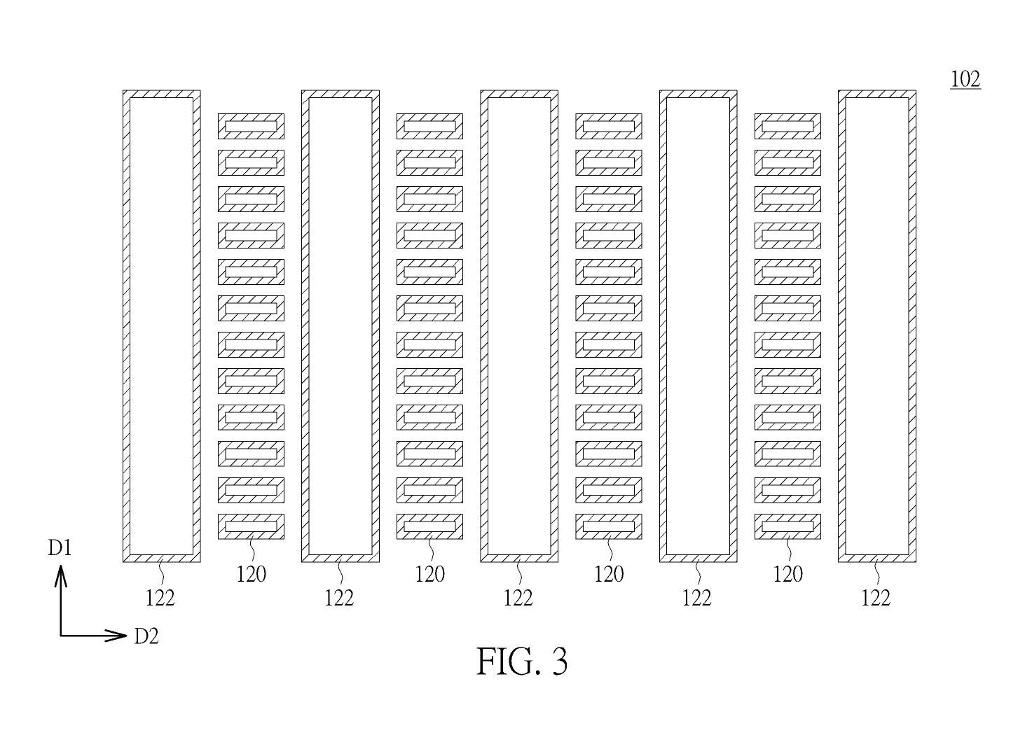

Please refer to FIG. 3. After forming the first spacers 120 and the second spacers 122, the first mandrel patterns 110 and the second mandrel patterns 112 are removed from the substrate 102. Consequently, only the hollow ring-shaped first spacers 120 and the hollow ring-shaped second spacers 122 are remained on the substrate 102. Simultaneously, the mandrel patterns in the active regions are removed and thus only the hollow ring-shaped spacers (not shown) are left in the active regions.

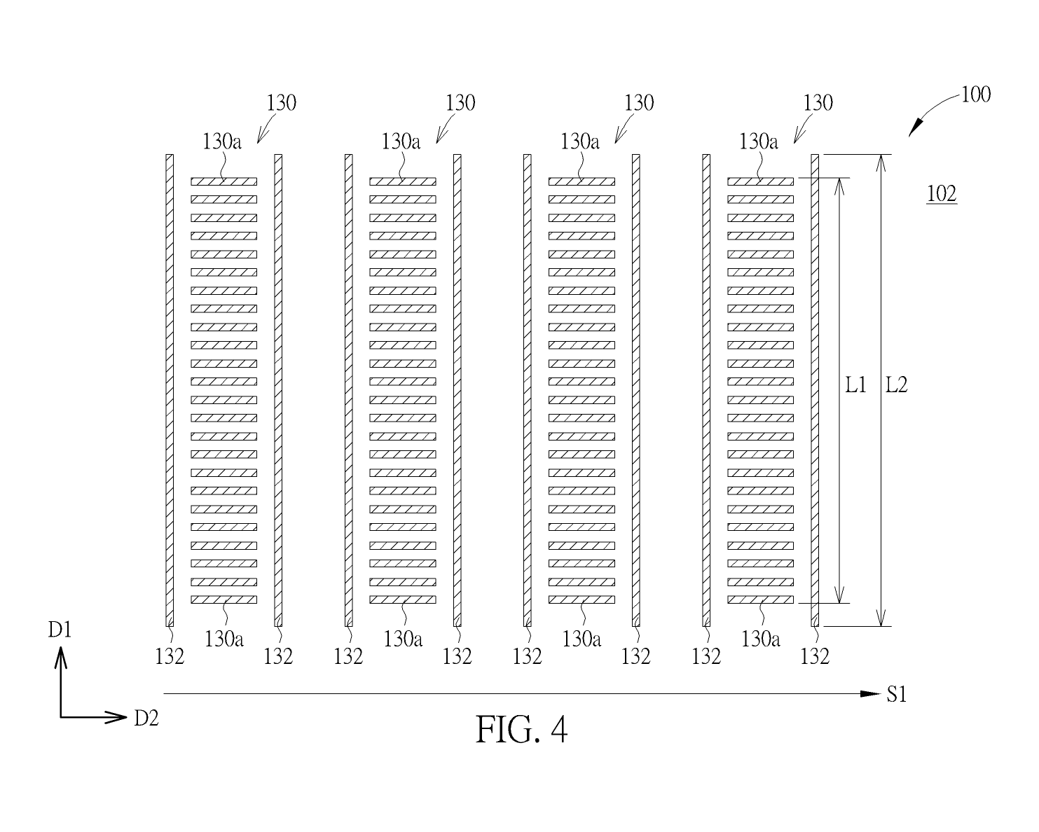

Please refer to FIG. 4. After removing all of the mandrel patterns (including the first mandrel patterns 110, the second mandrel patterns 112 and the mandrel patterns in the active regions) from the substrate 102, a fin-cutting process is performed. The fin-cutting process is performed to remove unnecessary spacers from the active regions so that the remained spacers serve to define placements, widths, and pitches of fins in which the sources/drains are accommodated. It is noteworthy that the fin-cutting process simultaneously removes portions of each first spacer 120 and portions of each second spacer 122. Therefore, a plurality of mark patterns 130 and a plurality of assistant bars 132 are formed on the substrate 102, as shown in FIG. 4. And the mark patterns 130 and the assistant bars 132 construct the measurement mark structure 100 of the preferred embodiment.

Please refer to FIG. 4 again. It is noteworthy that the measurement mark structure 100 provided by the preferred embodiment includes a plurality of mark patterns 130 and a plurality of pairs of assistant bars 132. The mark patterns 130 respectively include a plurality of segments 130a. And the assistant bars 132 and the segments 130a of each mark pattern 130 all include a strap shape. The segments 130a are arranged along the first direction D1 and extended along the second direction D2 while each of the assistant bars 132 is extended along the first direction D1. As mentioned above, the first direction D1 and the second direction D2 are perpendicular to each other. Each mark pattern 130 include a length L, which is a sum of widths of all segments 130a in the give mark pattern 130 and spacing widths between the given segments 130a. The assistant bars 132 include a length L2. As shown in FIG. 4, the length L2 of the assistant bars 132 is larger than the length L1 of the mark patterns 130.

Please still refer to FIG. 4. According to the preferred embodiment, one pair of assistant bars 132 is positioned at two opposite sides of one mark pattern 130. In other words, any mark pattern 130 is sandwiched in between one pair of assistant bars 132. Therefore, the mark patterns 130 are spaced apart from each other by two assistant bars 132 of different pairs and the substrate 102 while the two assistant bars 132 of different pairs are spaced apart from each other by the substrate 102. As shown in FIG. 4, any given mark pattern 130 and the pair of assistant bars 132 positioned at its two opposite sides form a ladder-shaped structure. The segments 130a of the mark pattern 130 form ladder rungs of the ladder-shaped structure and the pair of assistant bars 132 form ladder rails of the ladder-shaped structure. It is further noteworthy that the segments 130a of the mark pattern 130 and the pair of assistant bars 132 positioned at its two opposite sides are spaced apart from each other. In other words, the segments 130a of the mark pattern 130 and the pair of assistant bars 132 never contact each other.

According to the preferred embodiment, the first direction D1 is perpendicular to a scanning direction S1, and the second direction D2 is parallel with the scanning direction S1. Accordingly, the segments 130a of any mark pattern 130 are all parallel with the scanning direction S1 while all assistant bars 132 are perpendicular to the scanning direction S1. It is noteworthy that the mark patterns 130 are the practical and meaningful structures during scanning the measurement mark structure 100 according to the preferred embodiment. In detail, during measuring the overlay accuracy, the mark patterns 130 are scanned and compared with other mark patterns of measurement mark structures formed in the pre-layer or the successive layer. More important, any given mark pattern 130 is sandwiched in between one pair of assistant bars 132 which are perpendicular to the scanning direction S1 according to the preferred embodiment. In other words, the pair of assistant bars 132, which are perpendicular to the scanning direction S1, are positioned at two opposite ends of any segment 130a, which is parallel with the scanning direction S1. The pair of assistant bars 132 efficaciously remedy the edge rough problem, and thus alignment accuracy measurement is improved.

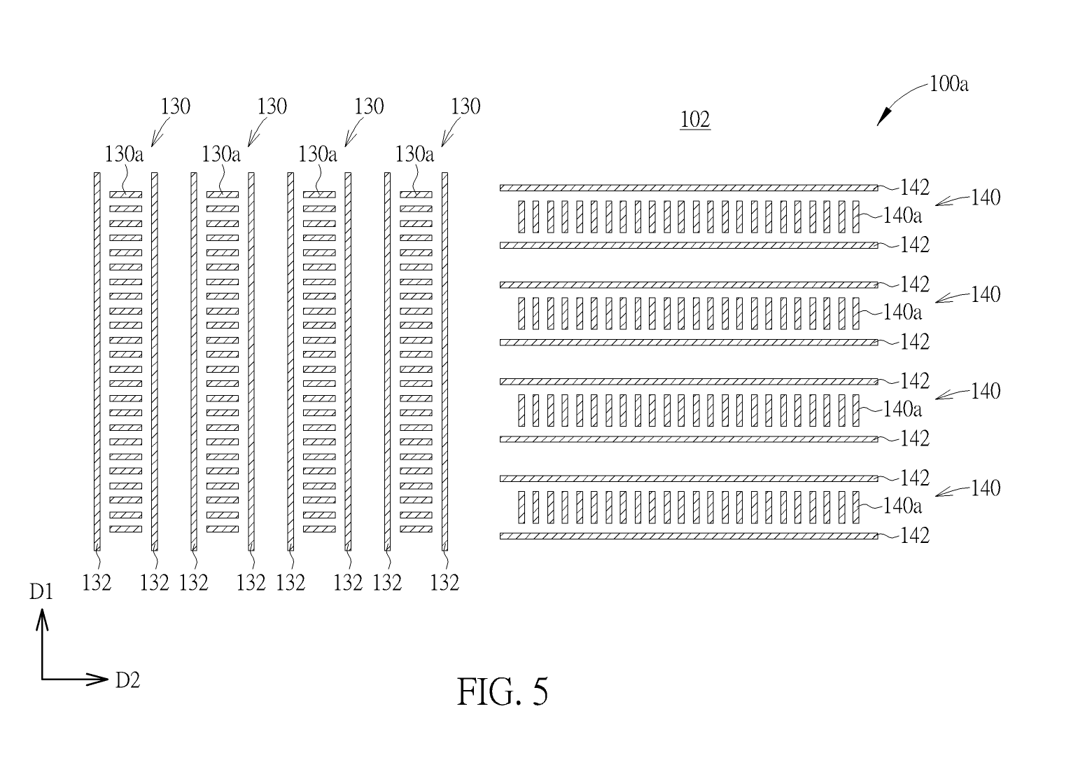

Please refer to FIG. 5, which is a schematic drawing illustrating a measurement mark structure provided by a second preferred embodiment of the present invention. It should be noted that elements the same in both of the first and second preferred embodiments are designated by the sane numerals and formed on the substrate 102 by the same steps. Elements the same in both of the first and second preferred embodiments also include the same arrangements. Therefore, those details are all omitted in the interest of brevity. The difference between the second and the first preferred embodiment is: The measurement mark structure 100a provided by the second preferred embodiment further includes a plurality mark patterns 140 and a plurality of pairs of assistant bars 142 formed on the substrate 102. The mark patterns 140 are respectively sandwiched in between one pair of assistant bars 142. The mark patterns 140 respectively include a plurality of segments 140a. And the assistant bars 142 and the segments 140a of each mark pattern 140 all include a strap shape. More important, the segments 140a are arranged along the second direction D2 and extended along the first direction D1 while each of the assistant bars 142 is extended along the second direction D2. Furthermore, a length of the assistant bars 142 is larger than a length of the mark patterns 140, which is a sum of widths of all segments 140a in the give mark pattern 140 and spacing widths between the given segments 140a. As shown in FIG. 5, any given mark pattern 140 and the pair of assistant bars 142 positioned at its two opposite sides form a ladder-shaped structure: The segments 140a of the mark pattern 140 form ladder rungs of the ladder-shaped structure and the pair of assistant bars 142 form ladder rails of the ladder-shaped structure. It is further noteworthy that the segments 140a of the mark pattern 140, the pair of assistant bars 142, the segments 130a of the mark pattern 130 and the pair of assistant bars 132 are all spaced apart from each other. In other words, the segments 140a, the assistant bars 142, the segments 130a, and the assistant bars 132 never contact each other.

In the preferred embodiment, the first direction D1 is parallel with the Y-direction while the second direction D2 is parallel with the X-direction. Therefore, the preferred embodiment provides the mark patterns 130 arranged parallel with the Y-direction and the mark patterns 140 arranged parallel with the X-direction. Also, the preferred embodiment provides the assistant bars 132 extended parallel with the Y-direction and the assistant bars 142 extended with the X-direction. More important, any given mark pattern 130/140 is sandwiched in between one pair of assistant bars 132/142. Therefore, the edge roughness in both of the X-direction and the Y-direction are remedied due to the assistant bars 132/142 formed at two opposite sides of the mark patterns 130/140 in accordance with the preferred embodiment. Consequently, alignment accuracy measurement is improved.

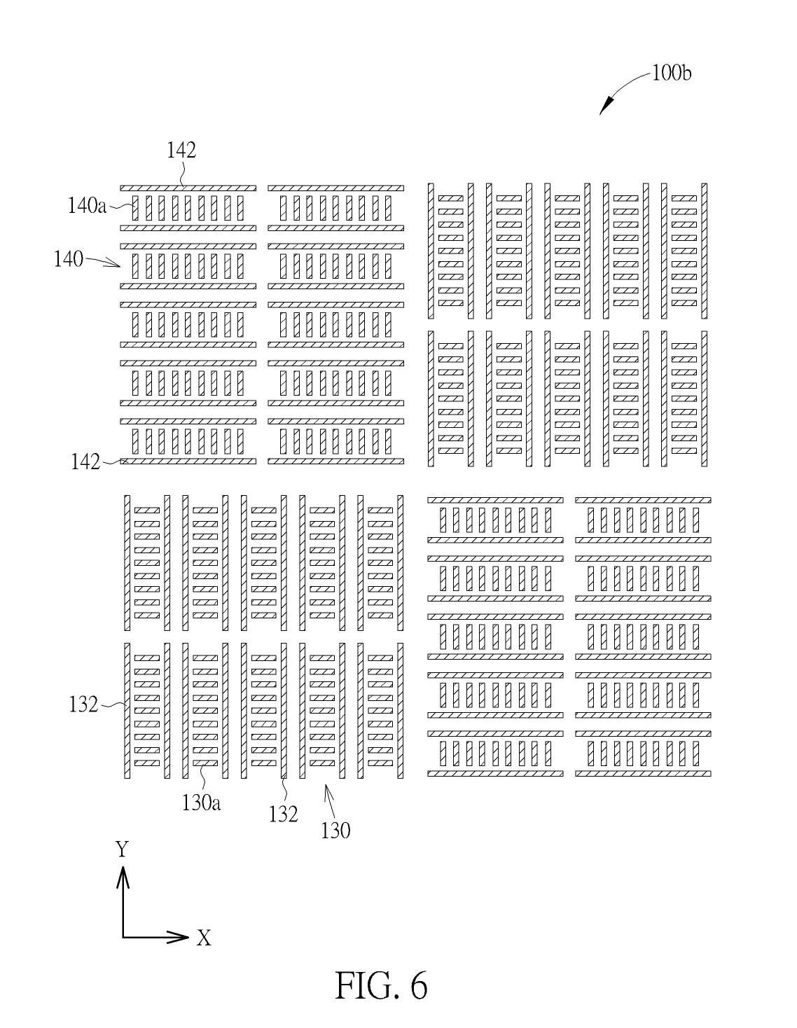

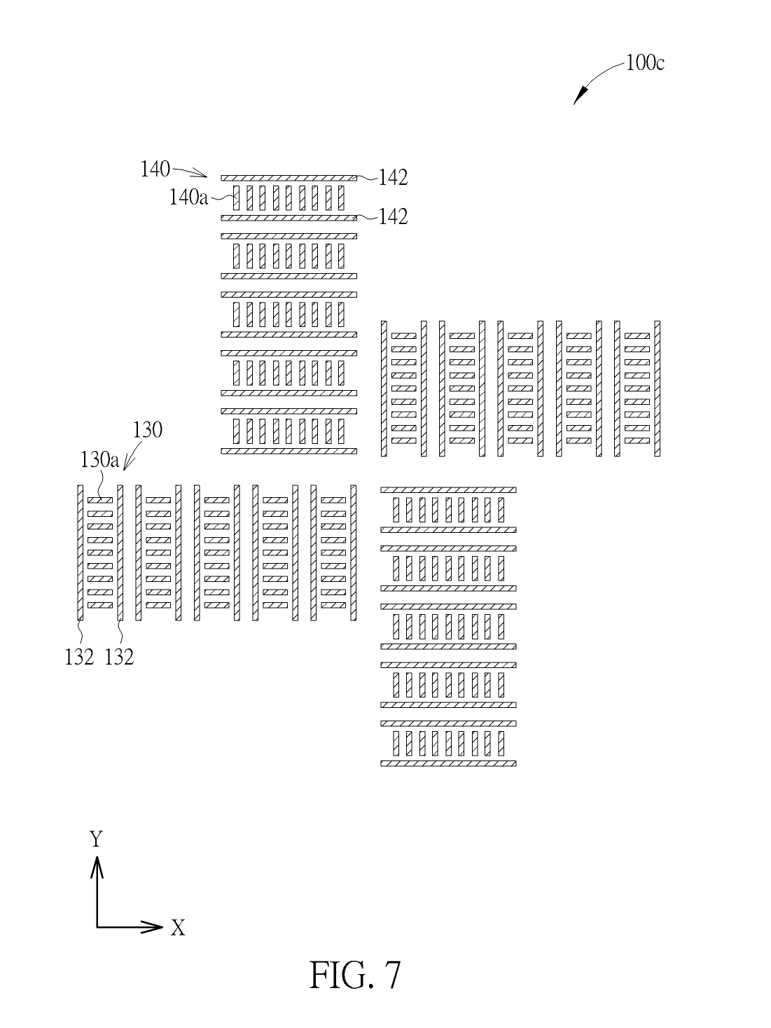

Please refer to FIGS. 6 and 7, which are schematic drawings respectively illustrating a modification to the second preferred embodiment. As shown in FIGS. 6 and 7, the measurement mark structure 100b and the measurement mark structure 100c respectively includes a plurality of mark patterns 130 and a plurality of mark patterns 140. The mark patterns 130 are arranged along the Y-direction while the mark patterns 140 are arranged along the X-direction. Each of the mark patterns 130 includes a plurality of segments 130a and each of the mark patterns 140 includes a plurality of segments 140a. More important, any given mark pattern 130 is sandwiched in between one pair of assistant bars 132 and any given mark pattern 140 is sandwiched in between one pair of assistant bars 142. The assistant bars 132 are extended along the Y-direction and the assistant bars 142 are extended along the X-direction. It is noteworthy that a length of the assistant bars 132 is larger than a length of the mark patterns 130 (a sum of widths of all segments 130a in the give mark pattern 130 and spacing widths between the given segments 130a), and a length of the assistant bars 142 is larger than a length of the mark patterns 140 (a sum of widths of all segments 140a in the give mark pattern 140 and spacing widths between the given segments 140a).

It is well-known to those skilled in the art that alignment accuracy in the X-direction and the Y-direction are both required. Therefore the measurement mark structures 100a, 100b and 100c of the second preferred embodiment and its modifications fulfill the requirement in both of the X-direction and the Y-direction by providing the mark patterns 130, the assistant bars 132, the mark patterns 140 and the assistant bars 132 in the X-direction and the Y-direction. Furthermore, by different arrangements and combinations of the mark patterns 130, the assistant bars 132, the mark patterns 140 and the assistant bars 132, different structures can be achieved. That is, various measurement mark structures can be easily offered, and are not limited to those depicted in FIGS. 5-7. In other words, the preferred embodiment can easily provide the measurement mark structures fulfilling different requirements and the provided measurement mark structures always remedy the edge rough problem. Thus alignment accuracy measurement is improved.

According to the present invention, one pair of assistant bars is always positioned at two opposite sides of any given mark pattern, which is a practical and meaningful structure in the alignment accuracy measurement, no matter in the X-direction and/or the Y-direction. The assistant bars remedy the edge rough problem, and thus alignment accuracy measurement is improved. Furthermore, the measurement mark structure provided by the present invention can be not only integrated in fin fabrication in the FinFET process, but also integrated in any semiconductor process involving fin-cutting process. Accordingly, the measurement mark structure provided by the present invention provides superior process flexibility and applicability.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A measurement mark structure comprising:
a mark pattern comprising a plurality of segments, and the segments being arranged along a first direction; and
a pair of assistant bars positioned at two opposite sides of the mark pattern, the assistant bars being extended along the first direction.

2. The measurement mark structure according to claim 1, wherein the first direction is perpendicular to a scanning direction.

3. The measurement mark structure according to claim 2, wherein the segments are extended along a second direction, and the second direction is perpendicular to the first direction.

4. The measurement mark structure according to claim 1, wherein the mark pattern and the pair of assistant bars form a ladder-shaped structure.

5. The measurement mark structure according to claim 1, wherein the segments of the mark pattern form ladder rungs of the ladder-shaped structure and the pair of assistant bars form ladder rails of the ladder-shaped structure.

6. The measurement mark structure according to claim 1, wherein the segments of the mark pattern and the pair of assistant bars are spaced apart from each other.

7. The measurement mark structure according to claim 1, wherein a length of the pair of assistant bars is larger than a length of the mark pattern.

8. A measurement mark structure comprising:
a substrate;
a plurality of first mark patterns positioned on the substrate, the first mark patterns respectively comprising a plurality of first segments and the first segments being arranged along a first direction; and
a plurality of pairs of first assistant bars positioned on the substrate, the first mark patterns being respectively sandwiched between one pair of first assistant bars, and the first assistant bars being extended along the first direction.

9. The measurement mark structure according to claim 8, wherein the first direction is perpendicular to a scanning direction.

10. The measurement mark structure according to claim 8, wherein the first segments of each first mark pattern are extended along a second direction, and the second direction is perpendicular to the first direction.

11. The measurement mark structure according to claim 10, further comprising:
a plurality of second mark patterns positioned on the substrate, the second mark patterns respectively comprising a plurality of second segments and the second segments being arranged along the second direction; and
a plurality of pairs of second assistant bars positioned on the substrate, the second mark patterns respectively being sandwiched between one pair of second assistant bars, and the second assistant bars being extended along the second direction.

12. The measurement mark structure according to claim 11, wherein the first mark patterns, the first assistant bars, the second mark patterns, and the second assistant bars are all spaced apart from each other.

13. The measurement mark structure according to claim 8, wherein the first mark patterns are spaced apart from each other by two first assistant bars of different pairs and the substrate.

14. The measurement mark structure according to claim 13, wherein the two first assistant bars of different pairs are spaced apart from each other by the substrate.

15. The measurement mark structure according to claim 8, wherein each of the first mark patterns and the pair of first assistant bars positioned at its two sides form a ladder-shaped structure.

16. The measurement mark structure according to claim 15, wherein the first segments of the first mark pattern form ladder rungs of the ladder-shaped structure and the pair of first assistant bars at its two sides form ladder rails of the ladder-shaped structure.

17. The measurement mark structure according to claim 16, wherein the first segments of the first mark pattern are spaced apart from the pair of first assistant bars.

18. The measurement mark structure according to claim 8, wherein a length of the first assistant bars is larger than a length of the first mark pattern.
